(19) United States
(12) Patent Application Publication
(10) Pub. No.: US 2018/0022336 A1
(43) Pub. Date: Jan. 25, 2018

(54) TRAVEL CONTROL DEVICE

(71) Applicant: DENSO CORPORATION, Kariya-city, Aichi-pref. (JP)

(72) Inventors: Youhei MORIMOTO, Kariya-city (JP); Noriaki IKEMOTO, Kariya-city (JP); Yuutarou ITOU, Kariya-city (JP); Masuhiro KONDO, Kariya-city (JP); Takahiro NARITA, Kariya-city (JP)

(21) Appl. No.: 15/548,544

(22) PCT Filed: Jan. 28, 2016
(86) PCT No.: PCT/JP2016/000439

§ 371 Date: Aug. 3, 2017

(30) Foreign Application Priority Data
Feb. 5, 2015 (JP) 2015-20852

(51) Int. Cl. B60W 10/06; B60W 10/08; F02D 29/02; B60W 30/16

(52) U.S. Cl. CPC B60W 10/06; B60W 30/16; B60W 10/08; F02D 29/02; F02D 2250/18; B60L 2240/421; F16H 2059/186

(57) ABSTRACT

A travel control device repeats a burn control that accelerates a vehicle at a target acceleration until speed of the vehicle reaches an upper limit speed of a vehicle speed range and a coasting control that makes the vehicle travel by means of inertia until the speed of the vehicle reaches a lower limit speed of the vehicle speed range. Further, a vehicle speed width that is a width of the vehicle speed range and the target acceleration are changed based on calculated travel resistance.

### CROSS REFERENCE TO RELATED APPLICATION

This application is based on Japanese Patent Application No. 2015-20852 filed on Feb. 5, 2015, the disclosure of which is incorporated herein by reference.

### TECHNICAL FIELD

The present disclosure relates to a travel control device that controls travel of a vehicle provided with an internal combustion engine.

### BACKGROUND ART

In order to improve fuel efficiency of a vehicle, there has been known a travel control device that executes burn-and-coast control. The burn-and-coast control is control that repeats control which accelerates a vehicle by means of driving force of an internal combustion engine (burn control) and control which stops generation of the driving force so that the vehicle travels by means of inertia (coasting control).

In such a burn-and-coast control, the internal combustion engine is operated in a condition with relatively high efficiency (high load) or the operation of the internal combustion engine is stopped. With this, since a period in which the internal combustion engine is operated in a condition with relatively low efficiency (low load) becomes short (or becomes zero), the fuel efficiency is improved compared to a case in which constant speed travel is executed.

In particular, in a hybrid vehicle or the like that is able to cover travel force when the internal combustion engine is stopped by driving force of a rotating electric machine, it is considered that an effect of the improvement of the fuel efficiency by the burn-and-coast control is large (for example, see Patent Literature 1).

The effect of the improvement of the fuel efficiency by the burn-and-coast control is not always constant, and it is changed due to travel resistance of the vehicle. According to a study conducted by the present inventors, knowledge that when the travel resistance is large, the effect of the improvement of the fuel efficiency by executing the burn-and-coast control is relatively small, and the fuel efficiency might be deteriorated depending on the condition compared to a case in which the constant speed travel is executed has been obtained.

### PRIOR ART LITERATURE

### Patent Literature

Patent Literature 1: JP 2007-291919 A

### SUMMARY OF INVENTION

It is an object of the present disclosure to provide a travel control device capable of further enhancing driving efficiency of an internal combustion engine by more appropriately executing burn-and-coast control.

A travel control device according to the present disclosure is configured to control travel of a vehicle provided with an internal combustion engine and to include a calculation unit that calculates travel resistance of the vehicle and a speed control unit that controls a speed of the vehicle. The speed control unit is configured to execute burn-and-coast control that repeats burn control which accelerates the vehicle by means of driving force of the internal combustion engine and coasting control which stops generation of the driving force of the internal combustion engine so that the vehicle travels by means of inertia. The burn control is to accelerate the vehicle at a predetermined acceleration until the speed of the vehicle reaches an upper limit of a predetermined vehicle speed range. The coasting control is to make the vehicle travel by the inertia until the speed of the vehicle reaches a lower limit of the vehicle speed range. A vehicle speed width that is a width of the vehicle speed range and the acceleration are changed based on the calculated travel resistance.

According to such a travel control device, the vehicle speed width and the acceleration as execution parameters of the burn-and-coast control are appropriately changed based on the travel resistance of the vehicle. The travel resistance of the vehicle denotes a characteristic that indicates a relationship between magnitude of resistance force that the traveling vehicle receives and a speed of the vehicle, and the travel resistance of the vehicle is changed in accordance with a shape of the vehicle, a wind speed around the vehicle, a condition of the road or the like. For example, when the vehicle travels on the wet road in raining, compared to when the vehicle travels on the dry road at the same speed, the resistance force that the vehicle receives is large. In other words, the travel resistance is large.

When the travel resistance is large, improvement of the fuel efficiency effect due to the burn-and-coast control is relatively small. Thus, the fuel efficiency can be further improved, for example, by executing the burn-and-coast control after either of the vehicle speed width or the acceleration is set to be small to change a condition nearly equal to the constant speed travel. Further, in a case in which the fuel efficiency is contrarily deteriorated due to the execution of the burn-and-coast control, both of the vehicle speed width and the acceleration may be changed to be zero, namely the burn-and-coast control may be stopped to be switched to the constant speed travel.

According to a travel control device according to the present disclosure, a driving efficiency of an internal combustion engine can be further enhanced by more appropriately executing the burn-and-coast control.

### BRIEF DESCRIPTION OF DRAWINGS

The above and other objects, features, and advantages of the present disclosure will become more apparent from the following detailed description made with reference to the accompanying drawings:

FIG. 1 is a diagram showing a whole configuration of a travel control device according to an embodiment of the present disclosure.

FIG. 2 is a diagram showing a relationship between a rotation speed and torque of an internal combustion engine and driving efficiency.

FIG. 3 is a diagram for showing burn-and-coast control.

FIG. 4 is a diagram showing travel resistance of a vehicle.

FIG. 5 is a diagram showing one example of change of the travel resistance.

FIG. 6 is a diagram showing one example of the change of the travel resistance.

FIG. 7 is a diagram showing change of fuel efficiency in accordance with the change of the travel resistance.

FIG. 8 is a diagram showing a relationship between settings of a vehicle speed width and acceleration and the driving efficiency.

FIG. 9 is a flowchart showing a flow of processing executed by the travel control device.

FIG. 10 is a flowchart showing a flow of processing that presumes the travel resistance.

FIG. 11 is a diagram for showing a method of calculating deceleration.

FIG. 12 is a diagram for showing a method of calculating a drift amount.

FIG. 13 is a diagram for showing a method of calculating a change rate.

FIG. 14 is a diagram for showing a method of determining whether the burn-and-coast control is executed.

FIG. 15 is a diagram for showing a method of calculating the acceleration among parameters of the burn-and-coast control.

FIG. 16 is a diagram for showing a method of calculating the vehicle speed width among the parameters of the burn-and-coast control.

FIG. 17 is a flowchart showing a flow of processing that presumes the travel resistance.

FIG. 18 is a diagram for showing automatic following control.

FIG. 19 is a flowchart showing a flow of processing in the automatic following control.

### EMBODIMENT FOR CARRYING OUT INVENTION

Hereinafter, an embodiment of the present disclosure will be described with reference to drawings. In order to facilitate understanding of the description, the same numeral reference is assigned to the same component in each figure as much as possible, and the repeated description thereof is therefore omitted.

A travel control device 10 according to the present embodiment is formed as a control device for controlling travel of a vehicle 20. “To control the travel” denotes that, for example, to execute control to automatize a part of operation of a driver by performing driving of a powertrain or braking of the vehicle 20 such that each of a speed, acceleration, and deceleration of the vehicle 20 is to be close to each target value. The detail of the control will be described below.

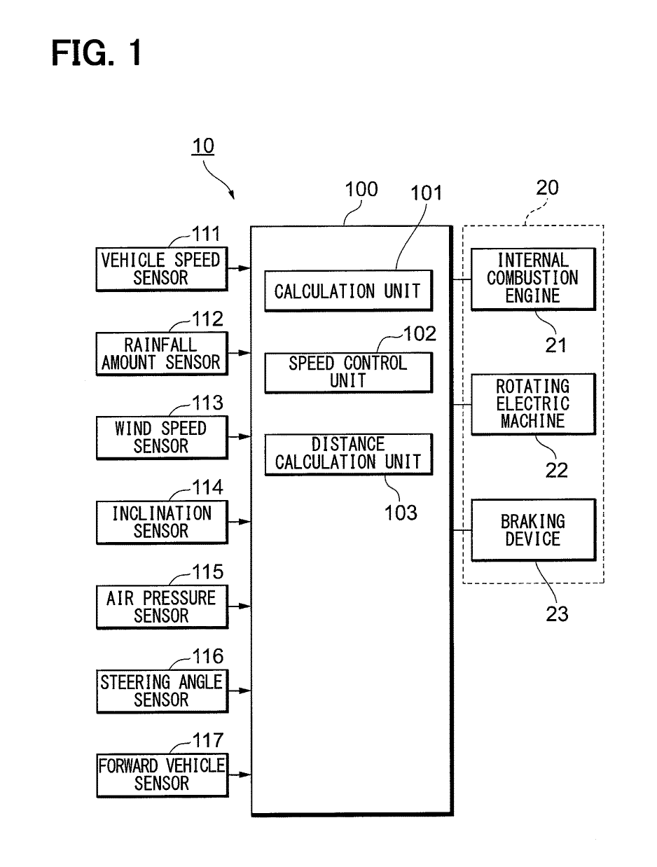

At first, the vehicle 20 that is a target of the control by the travel control device 10 will be described with reference to FIG. 1. The vehicle 20 is a so-called hybrid vehicle, and the vehicle 20 includes an internal combustion engine 21, a rotating electric machine 22, and a braking device 23.

The internal combustion engine 21 generates driving force by combusting mixture gas of fuel and air in a cylinder (not shown) and rotating a crank shaft (not shown) by means of expansion of the gas due to the combustion. The driving force is used as force to rotate a wheel (not shown) installed in the vehicle 20, namely used as travel force of the vehicle 20. Operation of the internal combustion engine 21 is controlled by the travel control device 10.

The rotating electric machine 22 is a so-called electric motor, and generates driving force (electromagnetic force) when receiving electric power from a battery (not shown). The driving force is used as the travel force of the vehicle 20 together with the driving force of the internal combustion engine 21 or instead of the driving force of the combustion engine 21. Operation of the rotating electric machine 22 is controlled by the travel control device 10.

The braking device 23 is a device that converts kinetic energy of the vehicle 20 into thermal energy by friction, to decelerate the vehicle 20 with the thermal energy. Further, the braking device 23 converts the kinetic energy of the vehicle 20 into electric energy by using the rotating electric machine 22, to decelerate the vehicle 20 (regenerative braking) with the electric energy. Operation of the braking device 23 is controlled by the travel control device 10.

Hereinafter, a configuration of the travel control device 10 will be described with continuously reference to FIG. 1. The travel control device 10 includes a main part 100 and various sensors (a vehicle speed sensor 111 described below, or the like).

The main part 100 is configured as a computer system provided with a CPU, a ROM, a RAM, and an input/output interface. The main part 100 includes, as functional control blocks, a calculation unit 101, a speed control unit 102, and a distance calculation unit 103.

The calculation unit 101 is to calculate travel resistance of the vehicle 20. The speed control unit 102 is to control speed or acceleration of the vehicle 20. The distance calculation unit 103 is to calculate a vehicular distance to a vehicle travelling ahead or a relative speed against the vehicle based on information input from a forward vehicle sensor 117 described below. The detailed functions of the calculation unit 101, the speed control unit 102, and the distance calculation unit 103 are described below.

The travel control device 10 includes the vehicle speed sensor 111, a rainfall amount sensor 112, a wind speed sensor 113, an inclination sensor 114, an air pressure sensor 115, a steering angle sensor 116, and the forward vehicle sensor 117 in order to acquire various pieces of information relating to the vehicle 20 and a surrounding environment of the vehicle. The measurement result of each of these sensors is sent to the main part 100 by an electric signal.

The vehicle speed sensor 111 is a sensor that measures a speed of the vehicle 20 (hereinafter, also referred to as “vehicle speed”). Here, the “speed” denotes a speed of the travelling vehicle 20 against the road.

The rainfall amount sensor 112 is a sensor that measures a rainfall amount around the vehicle 20. The main part 100 can detect a condition of the road (existence or thickness of a water film or the like), based on the rainfall amount sensor 112.

The wind speed sensor 113 is a sensor that measures a wind speed around the vehicle 20. The wind speed sensor 113 measures magnitude of the wind speed (including information of a fair wind and a head wind) along a travelling direction of the vehicle 20, and the wind speed sensor 113 sends the measurement result to the main part 100.

The inclination sensor 114 is a sensor that measures an incline angle of the vehicle 20 against a horizontal plane. The main part 100 can detect the incline angle (including information of an upward incline and a downward incline) of the road on which the vehicle 20 is travelling, based on the inclination sensor 114.

The air pressure sensor 115 is a sensor that measures air pressure of a tire (not shown) installed in the vehicle 20. Further, the air pressure sensor 115 may have a configuration in which the main part 100 presumes the air pressure based on a travelling condition of the vehicle 20 (for example, a relationship between a load of the internal combustion engine 21 and the vehicle speed, or the like), instead of a configuration in which the sensor for measuring the air pressure directly is arranged as described above.

The steering angle sensor 116 is a sensor that detects a rotation angle of a steering wheel (not shown) installed in the vehicle 20, namely to detect a steering angle. The main part 100 can detect change of the travelling direction of the vehicle 20, based on information sent from the steering angle sensor 116.

The forward vehicle sensor 117 is a sensor that measure the vehicular distance to other vehicle travelling ahead of the vehicle 20. As the forward vehicle sensor 117, for example, a millimeter-wave radar may be used. Further, the forward vehicle sensor 117 may be a device in which the forward vehicle is imaged by a camera and the vehicular distance is calculated by image analysis applied to the obtained image. The main part 100 can detect not only the vehicular distance described above based on the forward vehicle sensor 117 but also a relative speed to the forward vehicle based on change with time of the vehicular distance.

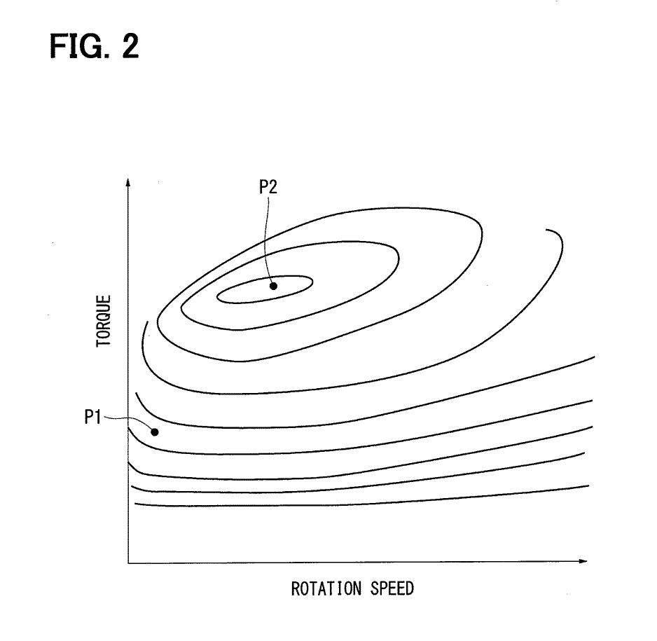

The driving efficiency of the internal combustion engine 21 will be described. It is known that the driving efficiency of the internal combustion engine 21 is not always constant and the driving efficiency of the internal combustion engine 21 is changed in accordance with generated torque (load) or a rotation speed. FIG. 2 is a diagram showing the driving efficiency of the internal combustion engine 21 in each driving condition (coordinate determined by the rotation speed and the torque) by a contour line when a horizontal axis is defined as the rotation speed of the internal combustion engine 21 and a vertical axis is defined as the torque.

As shown in FIG. 2, in the coordinate P2 in which the torque is relatively large, the driving efficiency of the internal combustion engine 21 is maximum, while in the coordinate P1 in which the torque is smaller and the rotation speed is lower than those in the coordinate P2, the driving efficiency of the internal combustion engine 21 is low. Thus, from a viewpoint of the driving efficiency, it is preferable that a state in which the internal combustion engine 21 is driven at a high rotation speed and at a high load is kept intermittently compared to a state in which the vehicle 20 travels at a constant speed, namely the state in which the internal combustion engine 21 is driven at a low rotation speed and a low load.

Thus, in the travel control device 10 according to the present embodiment, the driving efficiency can be enhanced by executing the burn-and-coast control. The burn-and-coast control denotes control in which control which accelerates the vehicle 20 by means of the driving force of the internal combustion engine 21 (burn control) and control which stops generation of the driving force of the internal combustion engine 21 so that the vehicle 20 travels by means of inertia (coasting control) are repeated.

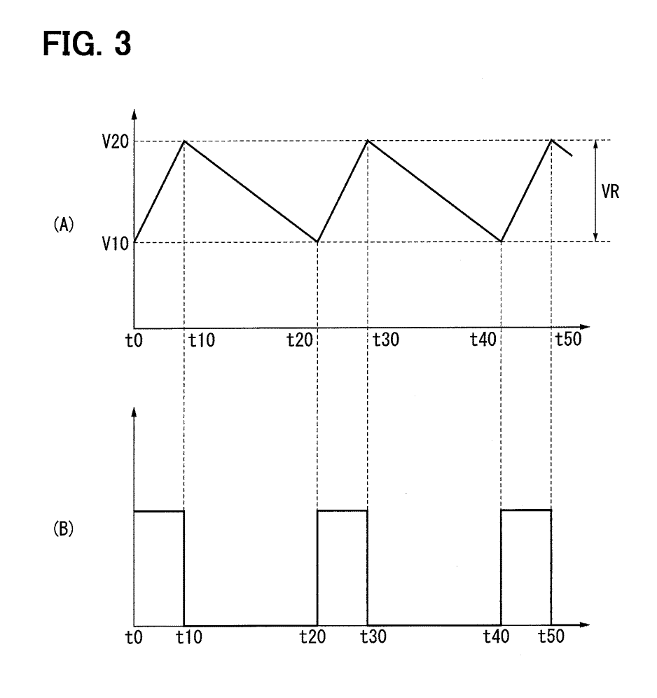

One example of the burn-and-coast control will be described with reference to FIG. 3. In FIG. 3, (A) is a graph showing change of the speed of the vehicle 20 with time when the burn-and-coast control is executed. In FIG. 3, (B) is a graph showing change of output (driving force) of the internal combustion engine 21 with time when the burn-and-coast control is executed as well.

In the example shown in FIG. 3, in each of a period between time t0 and time t10, a period between time t20 and time t30, and a period between time t40 and time t50, the burn control is executed. In the burn control, the driving force of the internal combustion engine 21 is adjusted such that the acceleration of the vehicle 20 is matched with predetermined target acceleration. Thus, as shown in (A) of FIG. 3, the vehicle speed is increased at a constant inclination (i.e., acceleration) in the period in which the burn control is executed.

In a period in which the burn control described above is not executed, namely in each of a period between time t10 and time t20, and a period between time t30 and time t40, the coasting control is executed. In the coasting control, generation of the driving force of the internal combustion engine 21 is stopped. Transmission of the driving force and the braking force to a driving wheel of the vehicle 20 is interrupted, and therefore the vehicle 20 travels by means of inertia (inertia energy).

At this time, the speed of the vehicle 20 is gradually decreased due to influence of air resistance or the like that the vehicle 20 receives. Thus, as shown in (B) of FIG. 3, the vehicle speed is decreased at a substantially constant inclination (i.e., deceleration) in the period in which the coasting control is executed.

As a result of that the burn control and the coasting control described above are alternately repeated, the speed of the vehicle 20 is set in a range between a lower limit speed V10 and an upper limit speed V20. In other words, the burn control is executed until the vehicle speed reaches the predetermined upper limit speed V20. Further, the coasting control is executed until the vehicle speed reaches the predetermined lower limit speed V10.

In the description below, a vehicle speed range between the lower limit speed V10 and the upper limit speed V20 is also described as “vehicle speed range VR”. The vehicle speed range VR is one of the parameters that specify a specific aspect of the burn-and-coast control together with the target acceleration described above.

As a result of that the burn-and-coast control described above is executed, the internal combustion engine 21 of the vehicle 20 is switched between a state in which the driving force is generated with relatively high driving efficiency (the burn control) and a state in which the generation of the driving force is stopped and the fuel is not consumed (the coasting control). In other words, in a state in which the driving force is generated, the driving only in the coordinate P2 shown in FIG. 2 or a coordinate near the coordinate P2 is performed, and therefore the driving at relatively low efficiency in the coordinate P1 (constant speed travel state) is not performed. As a result, compared to a case in which the constant speed travel is performed, the fuel efficiency of the vehicle 20 can be improved. Further, a period in which the vehicle speed is constant may be provided between the period in which the burn control is executed and the period in which the coasting control is executed.

Output of the internal combustion engine 21 necessary for matching the acceleration of the vehicle 20 with the target acceleration is changed in accordance with the travel resistance of the vehicle 20. Similarly, the deceleration when the coasting control is executed is also changed in accordance with the travel resistance of the vehicle 20. Thus, magnitude of the effect of the improvement of the fuel efficiency by executing the burn-and-coast control (hereinafter, the effect is also described as merely “fuel efficiency effect”) is changed in accordance with magnitude of the travel resistance.

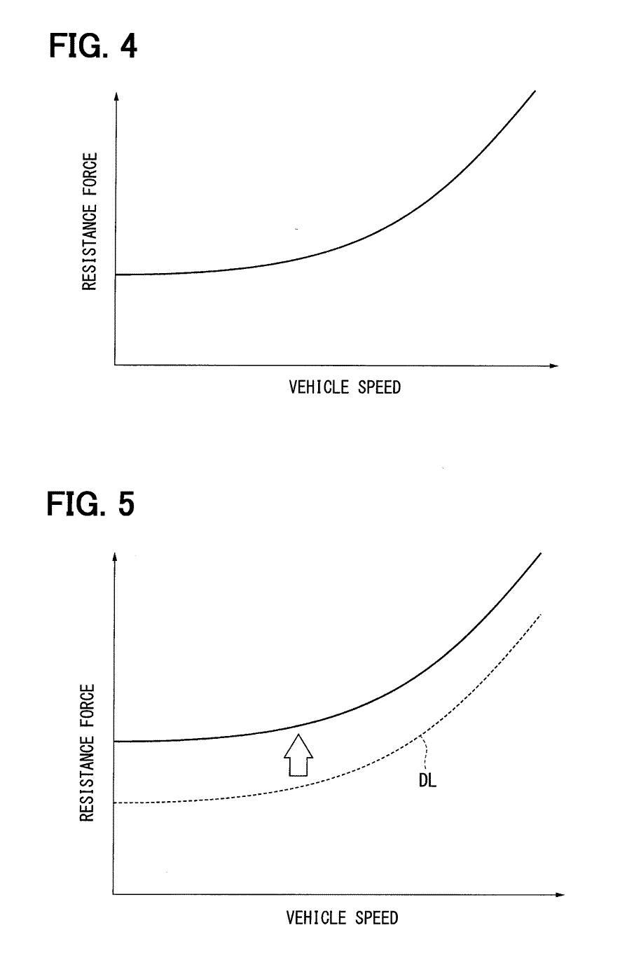

Further, as known widely, “the travel resistance” denotes a characteristic that indicates a relationship between the magnitude of the resistance force that the travelling vehicle receives and the vehicle speed of the vehicle. FIG. 4 shows one example of the travel resistance.

As shown in FIG. 4, when the vehicle speed is low, the air resistance that the vehicle 20 receives is relatively small, and rolling resistance that the tire receives from the road is also relatively small. On the other hand, when the vehicle speed is high, the air resistance and the rolling resistance are large. Thus, the resistance force that is the sum of the air resistance and the rolling resistance is increased. Further, the resistance force that the vehicle 20 receives includes various elements such as force (gravity force) received when the road is inclined, inertia force received as reaction force when the vehicle 20 is accelerated or the like, in addition to the air resistance and the rolling resistance. The resistance force shown along the vertical axis of FIG. 4 is the sum of all of the elements described above.

The travel resistance as shown in FIG. 4 is not always constant, and therefore the travel resistance is changed in accordance with a shape of the vehicle 20, the wind speed around the vehicle 20, a road condition, and the like. For example, when the vehicle 20 travels on a wet road in raining, the resistance force that the vehicle 20 receives is large compared to a case in which the vehicle travels on a dry road at the same speed. In other words, the travel resistance is large.

FIG. 5 shows one example of the travel resistance that is larger due to the bad condition of the road on which the vehicle 20 is travelling. In this case, the magnitude of the resistance force that the vehicle 20 receives is larger than that in a case shown in FIG. 4 by a certain amount (in any vehicle speed range). In other words, the graph indicating the travel resistance is a curve offset upwardly from the graph shown in FIG. 4 (shown by a dotted line DL in FIG. 5).

Further, FIG. 6 shows one example of the travel resistance that is larger due to a water film formed on the road on which the vehicle 20 is travelling. In this case, the magnitude of the resistance force that the vehicle 20 receives is larger than that in a case shown in FIG. 4. However, an increasing amount of the resistance force becomes larger as the vehicle speed becomes larger. In other words, the inclination of the graph indicating the travel resistance is larger compared to the graph shown in FIG. 4. This is because the magnitude of the resistance force that the tire receives from the water film is extremely larger in high speed travel.

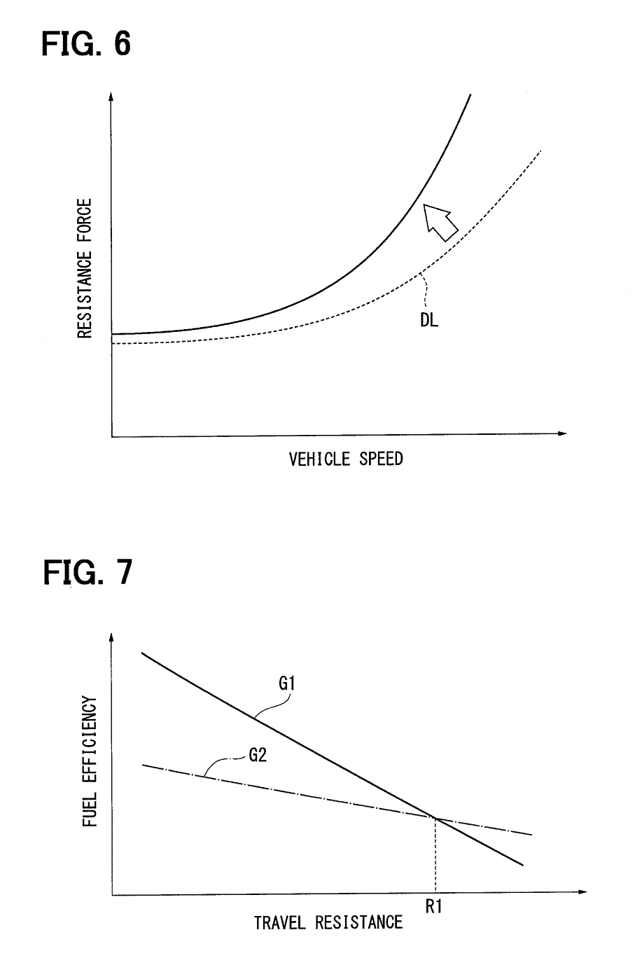

When the magnitude of the travel resistance is changed due to various causes as described above, the fuel efficiency effect is changed in accordance with the magnitude of the travel resistance. A line G1 in FIG. 7 is a graph schematically showing a relationship between the travel resistance and the fuel efficiency of the vehicle 20 when the burn-and-coast control is executed. Further, a line G2 in FIG. 7 is a graph schematically showing a relationship between the travel resistance and the fuel efficiency of the vehicle 20 when the burn-and-coast control is not executed, namely, in the constant speed travel. Further, a vertical axis of the graph in FIG. 7 indicates magnitude of the effect of the improvement of the fuel efficiency (goodness of the fuel efficiency).

As shown in FIG. 7, when the travel resistance is increased, the fuel efficiency of the vehicle 20 is deteriorated in accordance with the increase of the travel resistance. However, in the fuel efficiency (the line G1) when the burn-and-coast control is executed, a decrease ratio in accordance with the increase of the travel resistance is relatively large. Thus, when the travel resistance is small, the fuel efficiency is fine in a case in which the burn-and-coast control is executed, however when the travel resistance is large, the fuel efficiency effect becomes gradually small. In some cases (a case in which the travel resistance exceeds R1 in FIG. 7), the fuel efficiency might be deteriorated contrarily due to the burn-and-coast control.

Thus, the travel control device 10 according to the present embodiment is configured to calculate the travel resistance of the vehicle 20 and adjust the burn-and-coast control in accordance with the calculated travel resistance. Specifically, by changing the target acceleration and a width of the vehicle speed range (a value obtained by subtracting the lower limit speed V10 from the upper limit speed V20, and hereinafter, also referred to as “vehicle speed width”) as the parameters of the burn-and-coast control, the control to improve the effect of the fuel efficiency is executed.

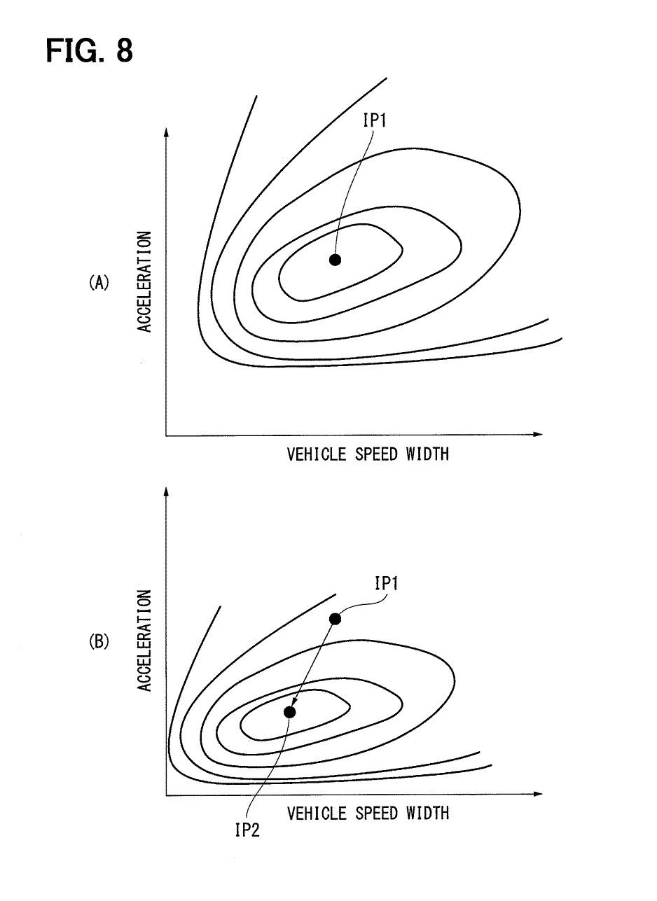

FIG. 8 shows the driving efficiency of the internal combustion engine 21 by a contour line in each condition (coordinate determined by the vehicle speed width and the target acceleration) when a horizontal axis is defined as the vehicle speed width and a vertical axis is defined as the target acceleration. In FIG. 8, (A) shows the driving efficiency in a case in which the travel resistance is relatively small. In FIG. 8, (B) shows the driving efficiency in a case in which the travel resistance is relatively large.

As shown in (A) of FIG. 8, when the travel resistance is small, the fuel efficiency effect is maximum in coordinate IP1 in which the vehicle speed width is set to be large and the target acceleration is also set to be large. On the other hand, as shown in (B) of FIG. 8, when the travel resistance is large, the fuel efficiency effect is maximum in coordinate IP2 in which the vehicle speed width is set to be small and the target acceleration is also set to be small. In this way, each of the appropriate values of the vehicle speed width and the target acceleration is not always constant, and the appropriate values are changed in accordance with the travel resistance. Thus, in the present embodiment, when it is detected that the travel resistance is large, each of the values of the target acceleration and the vehicle speed width is changed to be close to the coordinate IP2 from the coordinate IP1.

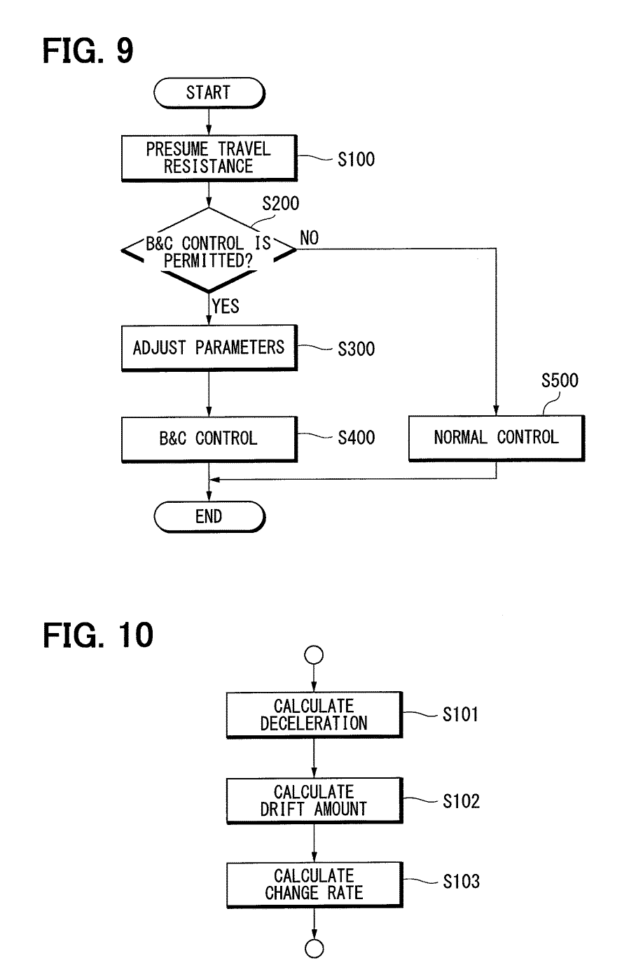

A detailed description of control executed by the travel control device 10 will be described with mainly reference to FIG. 9. A series of processing shown in FIG. 9 is repeatedly executed by the main part 100 every time when a predetermined control frequency elapses.

In the first Step S100, calculation (presumption) of the travel resistance by the calculation unit 101 is executed. The series of the processing shown in FIG. 10 shows what is executed in the processing in Step S100. In the present embodiment, each of a drift amount and a change rate is calculated as a representative index that shows a relationship between the magnitude of the resistance force that the vehicle 20 receives and the vehicle speed (namely, the magnitude of the travel resistance).

The “drift amount” denotes a parameter that indicates a height of a graph (position along the vertical axis) in the graph showing the relationship between the magnitude of the resistance force that the vehicle 20 receives and the vehicle speed as shown in FIG. 5. In other words, the “drift amount” is a parameter that indicates the magnitude of the resistance force that the vehicle 20 receives when the vehicle speed is a specific value (for example, 50 km/h). In the present embodiment, the drift amount is defined as a parallel movement amount along the vertical axis from the graph (for example, the dotted line DL in FIG. 5) that indicates a specific travel resistance as a reference.

The “change rate” is a parameter that indicates magnitude of inclination of the graph showing the relationship between the magnitude of the resistance force that the vehicle 20 receives and the vehicle speed as shown in FIG. 6. In other words, the “change rate” is a parameter that indicates a change amount of the magnitude of the resistance force when the vehicle speed is changed by a specific amount. In the present embodiment, the change rate is defined by a change amount of the magnitude of the resistance force when the speed is decreased from a specific speed (for example 80 km/h) by a predetermined amount (for example, 30 km/h). Instead of such a definition, the change rate may be defined by a change amount of the inclination in the graph that indicates a specific travel resistance as a reference (for example, the dotted line DL in FIG. 5).

First, in Step S101 for calculating the travel resistance, the deceleration when the coasting control is executed is calculated. In the present embodiment, each of deceleration K2 when the vehicle is decelerated and the vehicle speed reaches a predetermined setting vehicle speed VT20 and deceleration K1 when the vehicle is decelerated and the vehicle speed reaches a predetermined setting vehicle speed VT10 is calculated.

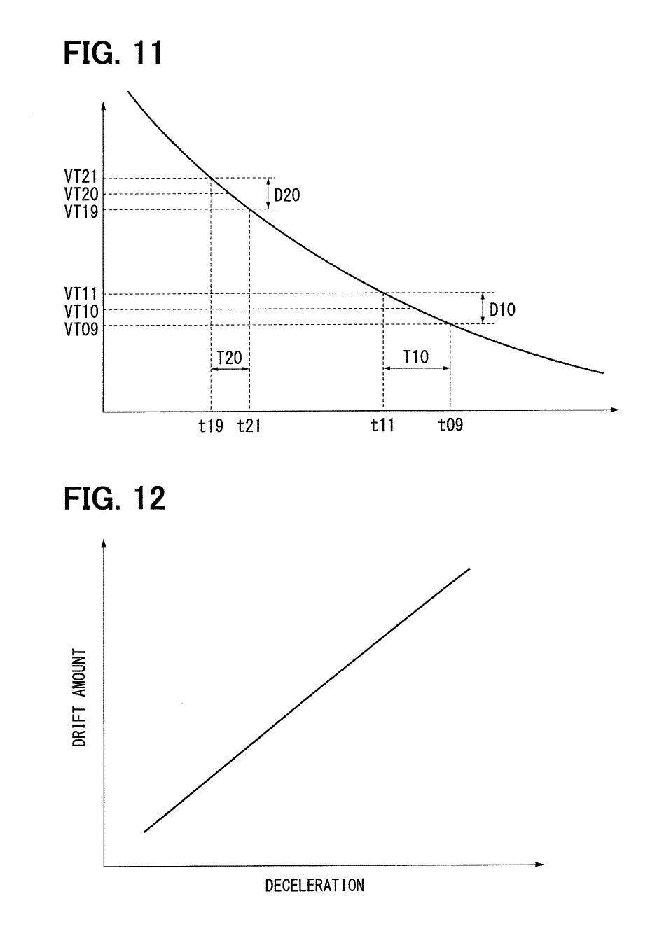

The graph of FIG. 11 shows change of the vehicle speed with time when the coasting control is executed. Such a change of the vehicle speed is always measured by the vehicle speed sensor 111 as described above and input into the main part 100.

In the calculation unit 101, time t19 when the vehicle speed reaches speed VT21 (in this case, 85 km/h) that is faster than the setting vehicle speed VT20 (for example, 80 km/h) by a predetermined amount (for example, 5 km/h) is stored. Further, time t21 when the vehicle speed reaches speed VT19 (in this case, 75 km/h) that is slower than the setting vehicle speed VT20 by a predetermined amount (for example, 5 km/h) is stored. The calculation unit 101 calculates the deceleration K2 when the vehicle is decelerated until the vehicle speed reaches the setting vehicle speed VT20 by dividing the difference between the speed VT21 and the speed VT19 by a length of period T20 between the time t19 and the time t21.

The deceleration K1 is similarly calculated. In the calculation unit 101, time t11 when the vehicle speed reaches speed VT11 (in this case, 55 km/h) that is faster than the setting vehicle speed VT10 (for example, 50 km/h) by a predetermined amount (for example, 5 km/h) is stored. Further, time t09 when the vehicle speed reaches speed VT09 (in this case, 45 km/h) that is slower than the setting vehicle speed VT10 by a predetermined amount (for example, 5 km/h) is stored. The calculation unit 101 calculates the deceleration K1 when the vehicle is decelerated until the vehicle speed reaches the setting vehicle speed VT10 by dividing the difference between the speed VT11 and the speed VT09 by a length of period T10 between the time t09 and the time t11

In Step S102 (FIG. 10) following Step S101, the drift amount is calculated based on the deceleration K1 calculated as described above. When the deceleration K1 is large, since it is presumed that the large resistance force is applied to the vehicle 20, the drift amount is calculated as a large value. A relationship between a value of the deceleration K1 and a value of the drift amount to be set in accordance with the value of the deceleration K1 is acquired by experiment or the theoretical formula in advance, and the relationship is stored as a map in a storing device installed in the main part 100.

FIG. 12 shows one example of the map as a graph. In the present embodiment, the drift amount is calculated as a value obtained by multiplying the value of the deceleration K1 and weight of the vehicle 20 and further a predetermined coefficient. Thus, the graph showing the relationship between the deceleration K1 and the drift amount is formed as a straight line rising in a direction toward the right as shown in FIG. 12.

In Step S103 (FIG. 10) following Step S102, the change rate is calculated based on the calculated deceleration K1 and the calculated deceleration K2. When the difference between the deceleration K2 and the deceleration K1 is large, the difference between the resistance force applied to the vehicle 20 at high speed and the resistance force applied to the vehicle 20 at low speed is large. Thus, as shown in FIG. 6, it is presumed that the inclination of the curve of the graph that indicates the travel resistance is large especially at the high speed. Thus, in such a case, the change rate is calculated as a large value.

A relationship between the difference between the deceleration K2 and the deceleration K1 and a value of the change rate to be set in accordance with the difference is acquired by experiment or the theoretical formula in advance, and the relationship is stored as a map in a storing device installed in the main part 100.

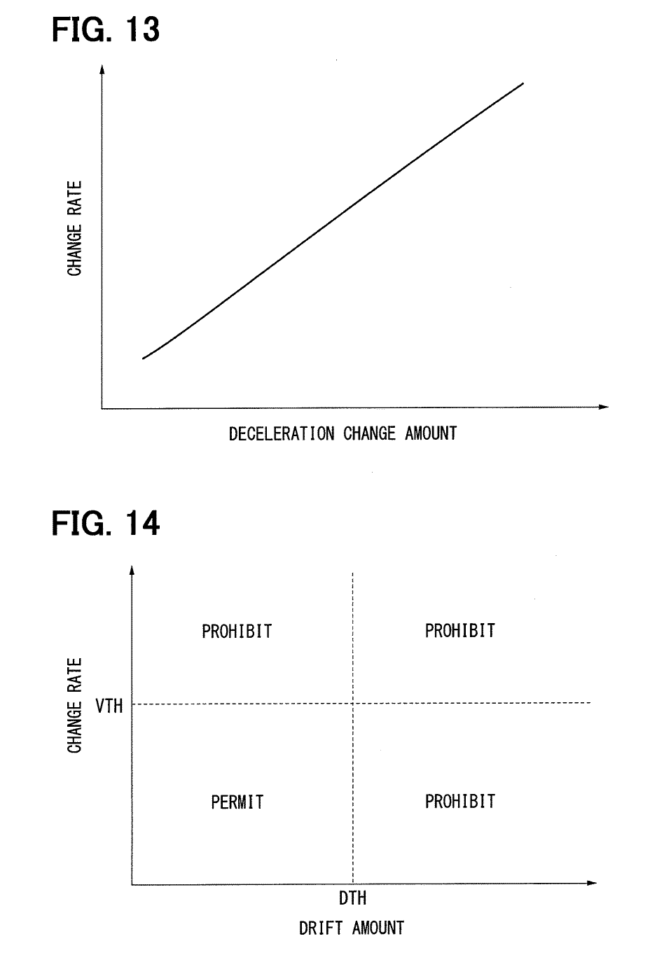

FIG. 13 shows one example of the map as a graph. In the present embodiment, the change rate is calculated as a value obtained by multiplying the difference (deceleration change amount) between the deceleration K2 and the deceleration K1 and the weight of the vehicle 20 and further a predetermined coefficient. Thus, the graph showing the relationship between the deceleration change amount and the change rate is formed as a straight line rising in a direction toward the right as shown in FIG. 13.

The description is continued by returning to FIG. 9. As described above, in Step S100, each of the drift amount and the change rate is calculated as the index that indicates the magnitude of the travel resistance.

In Step S200 following Step S100, it is determined whether the burn-and-coast control should be executed based on the calculated drift amount and the calculated change rate. As shown in FIG. 14, in the present embodiment, each of a threshold DTH relating to the drift amount and a threshold VTH relating to the change rate is defined. In a case in which the drift amount calculated in Step S100 is equal to or less than the threshold DTH and the change rate calculated in Step S100 is equal to or less than the threshold VTH, the execution of the burn-and-coast control is allowed, and the processing proceeds to Step S300. In other case, the execution of the burn-and-coast control is disallowed, and the processing proceeds to Step S500 and then normal control (the constant speed travel) is executed.

In this way, only in a case in which both of the drift amount and the change rate are relatively small, the burn-and-coast control is allowed and executed. In other words, in a case in which it is determined that the present travel resistance is relatively large, the burn-and-coast control is not executed. Thus, in a case in which the fuel efficiency effect is small due to the large travel resistance or in a case in which it is presumed that the fuel efficiency is contrarily deteriorated by the execution of the burn-and coast control, the burn-and-coast control is not executed but the normal control is executed. With this, the burn-and-coast control is prevented from being executed in a condition that does not contribute to the improvement of the fuel efficiency.

Further, the determination whether the execution of the burn-and-coast control is allowed may be performed based on both of the drift amount and the change rate as described above, however the determination may be performed based on either of the drift amount or change rate.

In Step S300, the parameter for executing the burn-and-coast control is adjusted. The target parameters to be adjusted are the target acceleration and the vehicle speed width as described above.

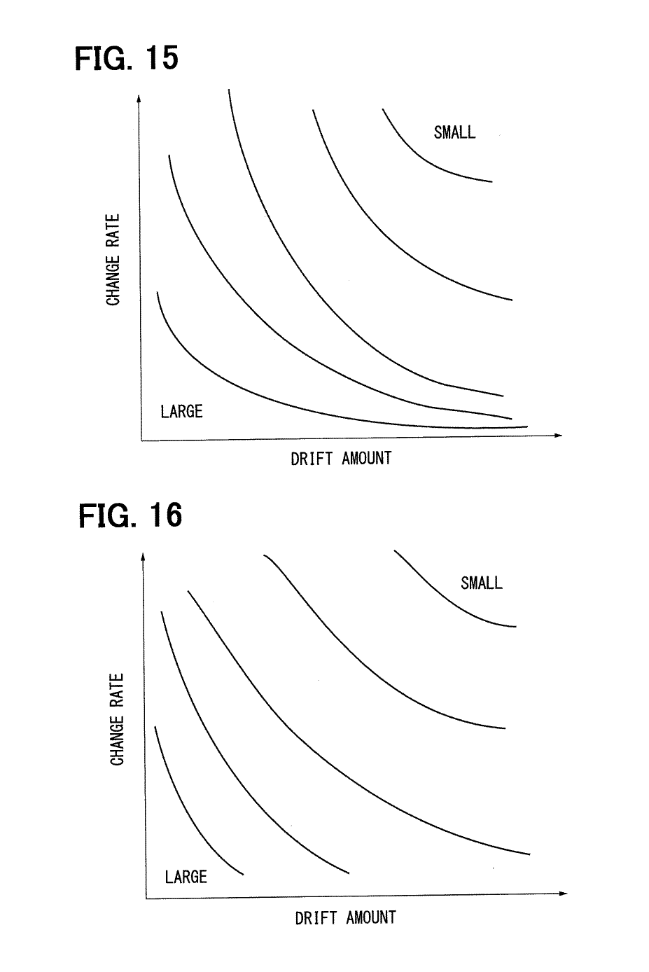

The adjustment of the target acceleration will be described. FIG. 15 shows the value of the target acceleration to be set by a contour line when a horizontal axis is defined as the drift amount and a vertical axis is defined as the change rate. In FIG. 15, the value of the target acceleration in a lower left region is maximum, and the value of the target acceleration in an upper right region is minimum.

The adjustment of the vehicle speed width is similar to the adjustment of the target acceleration. FIG. 16 shows the value of the change rate to be set by a contour line when a horizontal axis is defined as the drift amount and the vertical axis is defined as the change rate. In FIG. 16, the value of the change rate in a lower left region is maximum, the value of the change rate in an upper right region is minimum.

Since the value of the target acceleration and the value of the vehicle speed width are set (adjusted) as described above, as the travel resistance becomes larger, the value of the target acceleration becomes smaller and the value of the vehicle speed width becomes also smaller. As a result, since the target acceleration and the vehicle speed width are changed to be close to the coordinate IP2 from the coordinate IP1 in (B) of FIG. 8, the fuel efficiency effect improves when the travel resistance is large. Further, a configuration in which either of the target acceleration or the vehicle speed width is adjusted may be adopted instead of the configuration in which both of the target acceleration and the vehicle speed width are adjusted.

In Step S400 following Step S300, the burn-and-coast control is executed based on the target acceleration and the vehicle speed width set as described above.

Further, the calculation of the travel resistance in Step S100 may be executed based on the decelerations (K1, K2) during the coasting control as described in the present embodiment, however the calculation of the travel resistance may be executed based on another method.

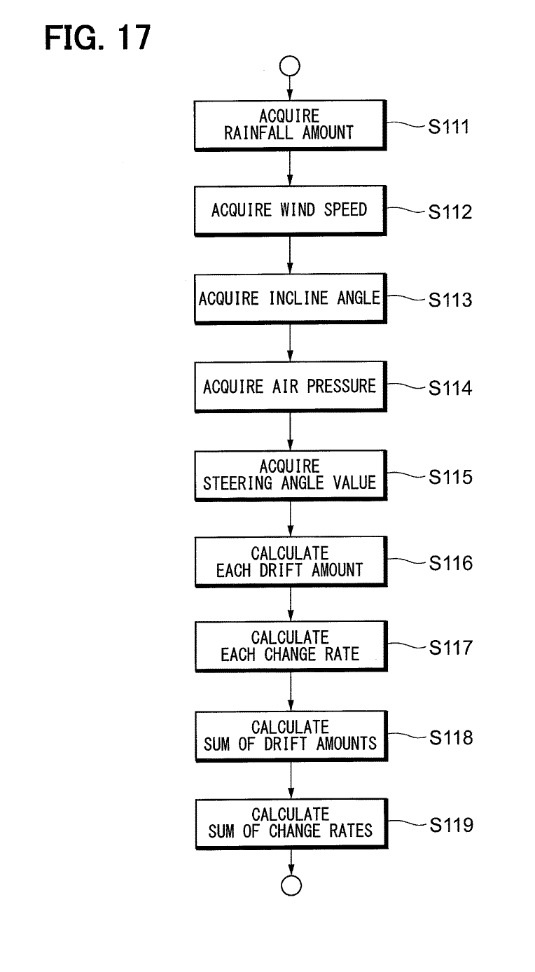

FIG. 17 is a flowchart showing an example of processing that calculates the travel resistance, based on information from various sensors (the rainfall amount sensor 112 or the like). A series of processing shown in FIG. 17 is executed by the calculation unit 101 instead of the processing shown in FIG. 10.

In Step S111, a measurement value of a rainfall amount is acquired from the rainfall amount sensor 112. In Step S112, a measurement value of a wind speed is acquired from the wind speed sensor 113. In Step S113, a measurement value of an incline angle is acquired from the inclination sensor 114. In Step S114, a measurement value of air pressure of a tire is acquired from the air pressure sensor 115. In Step S115, a measurement value of a steering angle is acquired from the steering angle sensor 116.

In Step S116 following Step S111 through Step S115, the drift amount is calculated based on the value measured by each sensor. The definition of the drift amount in the example shown in FIG. 17 is the same as the definition of the drift amount described above.

In the storage device in the main part 100, a relationship between the rainfall amount measured by the rainfall amount sensor 112 and the value of the drift amount to be set based on the rainfall amount is stored in advance as a map. In Step S116, the measurement value of the rainfall amount sensor 112 is converted into the drift amount by referring to the map.

Similarly, relating to other sensors, a relationship between the wind speed and the drift amount, a relationship between the incline angle and the drift amount and the like are stored in advance in the storage device as maps, respectively. In Step S116, each of the measurement values is converted into the drift value by referring to the map corresponding to each of the measurement values. As a result, the values of the drift amounts corresponding to the respective sensors are independently calculated.

In Step S117 following Step S116, the change rate is calculated based on the value measured by each sensor. The definition of the change rate in the example shown in FIG. 17 is the same as the definition of the change rate described above.

In the storage device in the main part 100, a relationship between the rainfall amount measured by the rainfall amount sensor 112 and the change rate to be set based on the rainfall amount is stored in advance as a map. In Step S117, the measurement value of the rainfall amount sensor 112 is converted into the change rate by referring to the map.

Similarly, relating to other sensors, a relationship between the wind speed and the change rate, a relationship between the incline angle and the change rate and the like are stored in advance in the storage device as maps, respectively. In Step S117, each of the measurement values is converted into the change rate by referring to the map corresponding to each of the measurement values. As a result, the values of the change rates corresponding to respective sensors are independently calculated.

In Step S118 following Step S117, the sum of a plurality of the drift amounts calculated in Step S116 is calculated, and the obtained value is newly used as “drift amount”. Similarly, in Step S119 following Step S118, the sum of a plurality of the change rates calculated in Step S117 is calculated, and the obtained value is newly used as “change rate”.

As described above, the travel resistance may be calculated based on information other than the information from the vehicle speed sensor 111. When the present disclosure is carried out, a method of determining the magnitude of the travel resistance is not limited to a specific method, and another method other than the method described above may be adopted.

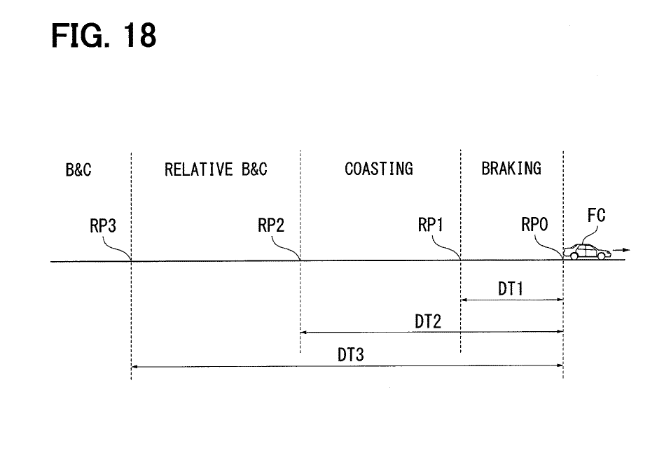

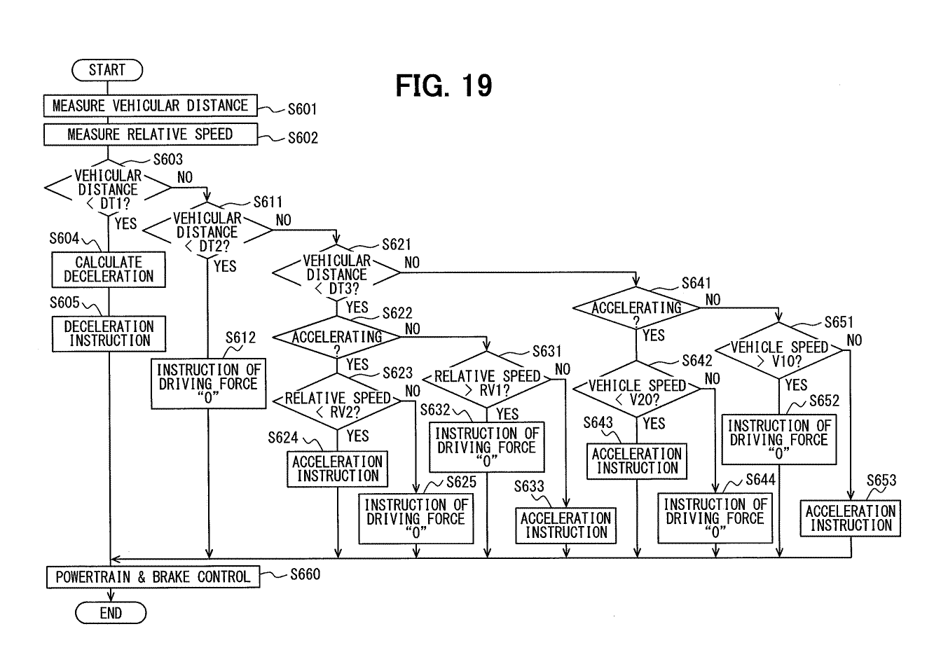

Next, an automatic following control will be described with reference to FIG. 18 and FIG. 19. The automatic following control denotes control that travels the vehicle 20 so as to automatically follow another vehicle (hereinafter, referred to as “vehicle FC”) traveling ahead of the vehicle 20 and that is executed by the travel control device 10.

As the outline is shown in FIG. 18, in the automatic following control according to the present embodiment, when the distance between a rear end RP0 of the vehicle FC and a front end of the vehicle 20 (hereinafter, referred to as merely “vehicular distance”) is less than a predetermined distance DT1 (when the front end of the vehicle 20 is located ahead of a position RP1), the deceleration by means of operation of the braking device 23 is performed.

Further, when the vehicular distance is equal to or more than the distance DT1 and less than a predetermined distance DT2 (when the front end of the vehicle 20 is located between the position RP1 and a position RP2), only the coasting control is executed.

Further, when the vehicular distance is equal to or more than the distance DT2 and less than a predetermined distance DT3 (when the front end of the vehicle 20 is located between the position RP2 and a position RP3), the burn-and-coast control based on the relative speed is executed. “The burn-and-coast control based on the relative speed” will be described below.

When the vehicular distance is equal to or more than the distance DT3 (when the front end of the vehicle 20 is located far away from the position RP3), the burn-and-coast control as described above is executed.

FIG. 19 is a flowchart showing a specific processing flow in the automatic following control. A series of processing shown in FIG. 19 is repeatedly executed by the main part 100 every time when a predetermined control frequency elapses. In the first Step S601, the vehicular distance is measured. Specifically, the vehicular distance is calculated based on a measurement value of the forward vehicle sensor 117. The calculation of the vehicular distance is executed by the distance calculation unit 103.

In Step S602 following Step S601, a relative speed to the vehicle FC, namely a speed of the vehicle 20 against a speed of the vehicle FC, is measured. In the present embodiment, the relative speed is calculated based on the change with time of the measurement value of the forward vehicle sensor 117. The calculation of the relative speed is executed by the distance calculation unit 103. Further, in the description below, when “speed” or “vehicle speed” is merely described, it denotes a speed against the road.

In Step S603 following Step S602, it is determined whether the calculated vehicular distance is less than the distance DT1. In a case in which the vehicular distance is less than the distance DT1, the processing proceeds to Step S604.

In Step S604, the deceleration at the present moment is calculated. The calculation of the deceleration is executed by a similar method to the calculation method of the decelerations K1, K2 described with reference to FIG. 11.

In Step S605 following Step S604, deceleration instruction is generated. In other words, a control instruction value in the main part 100 is changed such that control which compulsorily decelerates the vehicle 20 instead of the travel by means of inertia is executed after this.

In Step S660 following Step S605, the control based on the control instruction value is executed by the speed control unit 102. In this case, the braking device 23 is activated, and the vehicle 20 is decelerated by means of either of friction braking or regenerative braking. As a result, the vehicular distance gradually becomes large to be larger than the distance DT1 in the end.

In a case in which the vehicular distance is equal to or more than the distance DT1 in Step S603, the processing proceeds to Step S611. In Step S611, it is determined whether the vehicular distance is less than the distance DT2. In a case in which the vehicular distance is less than the distance DT2, the processing proceeds to Step S612.

In Step S612, the control instruction value is changed such that the generation of the driving force of the internal combustion engine 21 is stopped and the vehicle 20 travels by means of the inertia after this. Thus, when the processing proceeds to Step S660 from Step S612, the coasting control is executed after that. Since the vehicle 20 travels by means of the inertia, if the speed of the vehicle FC is constant, the vehicular distance gradually (slowly) becomes large.

In a case in which the vehicular distance is equal to or more than the distance DT2 in Step S611, the processing proceeds to Step S621. In Step S621, it is determined whether the vehicular distance is less than the distance DT3. In a case in which the vehicular distance is less than the distance DT3, the processing proceeds to Step S622.

In Step S622, it is determined whether the relative speed of the vehicle 20 is increased, namely whether the vehicle 20 is in accelerating relatively against the vehicle FC. In a case in which the vehicle 20 is in accelerating relatively, the processing proceeds to Step S623.

In Step S623, it is determined whether the relative speed is less than a predetermined upper limit speed RV2. In a case in which the relative speed is less than the upper limit speed RV2, the processing proceeds to Step S624. In Step S624, the control instruction value is changed such that the relative acceleration against the vehicle FC is matched with a specific target relative acceleration. Thus, when the processing proceeds to Step S660 from Step S624, the burn control is executed after that. The relative speed gradually increases to be close to the upper limit speed RV2.

In a case in which the relative speed is equal to or more than the upper limit speed RV2 in Step S623, the processing proceeds to Step S625. In Step S625, the control instruction value is changed such that the generation of the driving force of the internal combustion engine 21 is stopped and the vehicle 20 travels by means of the inertia after this. Thus, when the processing proceeds to Step S660 from Step S625, the coasting control is executed after that. Since the vehicle 20 travels by means of the inertia, if the speed of the vehicle FC is constant, the relative speed gradually decreases to close to a lower limit speed RV1 described below.

In Step S622, in a case in which the relative speed of the vehicle 20 is not in increasing, the processing proceeds to Step S631. In Step S631, it is determined whether the relative speed is more than a predetermined lower limit speed RV1. In a case in which the relative speed is more than the lower limit speed RV1, the processing proceeds to Step S632.

In Step S632, the control instruction value is changed such that the generation of the driving force of the internal combustion engine 21 is stopped and the vehicle 20 travels by means of the inertia after this. Thus, when the processing proceeds to Step S660 from Step S632, the coasting control is executed after that. Since the vehicle 20 travels by means of the inertia, if the speed of the vehicle FC is constant, the relative speed gradually decreases to close to the lower limit speed RV1.

In Step S631, in a case in which the relative speed is equal to or less than the lower limit speed RV1, the processing proceeds to Step S633. In Step S633, the control instruction value is changed such that the relative acceleration against the vehicle FC is matched with the target relative acceleration. Thus, when the processing proceeds to Step S660 from Step S633, the burn control is executed after this. The relative acceleration gradually increases to be close to the upper limit speed RV2.

As apparent from the description above, the control (Steps S622, S623, S624, S625, S631, S632, S633) executed after the vehicular distance is determined to be less than the distance DT3 in Step S621 is formed such that the relative speed is set in a range between the lower limit speed RV1 and the upper limit speed RV2 by repeating a state in which the relative acceleration of the vehicle 20 is matched with the target acceleration (the burn control) and a state in which the internal combustion engine 21 is stopped so that the vehicle 20 travels by means of the inertia (the coasting control). In other words, it is deemed to be a control such that the vehicle speed range in the burn-and-coast control described with reference to FIG. 3 or the like is set as a region for the relative speed, namely the burn-and-coast control based on the relative speed.

In Step S621, in a case in which the vehicular distance is equal to or more than the distance DT3, the processing proceeds to Step S641. In Step S641, it is determined whether the speed of the vehicle 20 (against the road) is in increasing, namely whether the vehicle 20 is in accelerating. In a case in which the vehicle 20 is in accelerating, the processing proceeds to Step S642.

In Step S642, it is determined whether the speed of the vehicle 20 is less than the upper limit speed V20. In a case in which the vehicle speed is less than the upper limit speed V20, the processing proceeds to Step S643. In Step S643, the control instruction value is changed such that the vehicle speed is matched with the target acceleration. Thus, when the processing proceeds to Step S660 from Step S643, the burn control is executed after this. The vehicle speed gradually increases to close to the upper limit speed V20.

In Step S642, in a case in which the vehicle speed is equal to or more than the upper limit speed V20, the processing proceeds to Step S644. In Step S644, the control instruction value is changed such that the generation of the driving force of the internal combustion engine 21 is stopped and the vehicle 20 travels by means of the inertia after this. Thus, when the processing proceeds to Step S660 from Step S644, the coasting control is executed after that. Since the vehicle 20 travels by means of the inertia, the vehicle speed gradually decreases to close to the lower limit speed V10.

In Step S641, in a case in which the vehicle 20 is not in accelerating, the processing proceeds to Step S651. In Step S651, it is determined whether the vehicle speed is more than the lower limit speed V10. In a case in which the vehicle speed is more than the lower limit speed V10, the processing proceeds to Step S652.

In Step S652, the control instruction value is changed such that the generation of the driving force of the internal combustion engine 21 is stopped and the vehicle 20 travels by means of the inertia after this. Thus, when the processing proceeds to Step S660 from Step S652, the coasting control is executed after that. Since the vehicle 20 travels by means of the inertia, the vehicle speed gradually decreases to be close to the lower limit speed V10.

In Step S651, in a case in which the vehicle speed is equal to or less than the lower limit speed V10, the processing proceeds to Step S653. In Step S653, the control instruction value is changed such that the acceleration of the vehicle 20 (against the road) is matched with the target acceleration. Thus, when the processing proceeds to Step S660 from Step S653, the burn control is executed after this. The vehicle speed gradually increases to close to the upper limit speed V20.

As apparent from the description above, the control (Steps S641, S642, S643, S644, S651, S652, S653) executed after the vehicular distance is determined to be equal to or more than the distance DT3 in Step S621 is the same as the control in which the vehicle speed is set in the range (the vehicle speed range VR) between the lower limit speed V10 and the upper limit speed V20, namely the burn-and-coast control described above with reference to FIG. 3.

As described above, in the travel control device 10 according to the present embodiment, the control of the vehicle 20 is changed in accordance with the length of the vehicular distance to the vehicle FC. When the vehicular distance is less than the distance DT1, since the deceleration of the vehicle 20 by the braking device 23 is compulsorily executed, the vehicular distance is prevented from being too short.

When the vehicular distance is equal to or more than the distance DT1 and less than the distance DT2, the coasting control is executed. Accordingly, the improvement of the fuel efficiency due to the stop of the internal combustion engine 21 can be achieved with the vehicular distance being ensured to some extent.

When the vehicular distance is equal to or more than the distance DT2 and less than the distance DT3, the burn-and-coast control based on the relative speed is executed. Accordingly, the improvement of the fuel efficiency can be achieved by driving the internal combustion engine 21 in a condition with high efficiency with the vehicle 20 automatically following the vehicle FC traveling ahead of the vehicle 20.

When the vehicular distance is equal to or more than the distance DT3, the following after the vehicle FC is stopped and the normal burn-and-coast control is executed. With this, even if the automatic following control is not executed, the improvement of the fuel efficiency due to the burn-and-coast control can be achieved.

The travel resistance that is a characteristic indicating the relationship between the resistance force and the vehicle speed is not merely scalar quantity but is shown by the graph shown in FIG. 4. Thus, in the present embodiment, as the indexes that indicate the magnitude of the travel resistance, two parameters of the drift amount and the change rate are used. However, a method relating to how to determine the magnitude of the travel resistance is not limited to a specific method in carrying out the present disclosure.

For example, the curve showing the travel resistance as shown in FIG. 4 is represented by a quadratic equation such as an expression (1) described below, and coefficients (a, b, c) of respective terms may be used as the indexes that indicate the magnitude of the travel resistance. For example, a configuration in which the coefficients a, b, c are respectively set by associating the measurement values of the respective sensors installed in the vehicle 20 with a predetermined map may be adopted. Further, “v” in the expression (1) denotes a variable that indicates the vehicle speed.

Resistance Force=av²+bv+c (1)

The embodiment of the present disclosure has been described above with reference to the specific example. However, the present disclosure is not limited to the specific example described above. In other words, a configuration in which a design modification is added to the specific example described above by a person skilled in the art as needed should be included in the scope of the present disclosure as long as it has a feature of the present disclosure. For example, each component, arrangement, material, condition, shape, size or the like provided in each specific example described above is not limited to those described as an example and may be modified as needed. Further, the components provided in the embodiment described above may be combined with each other as long as it is technically possible, and a configuration having the combined component may be included in the scope of the present disclosure as long as it has a feature of the present disclosure.

1. A travel control device for controlling travel of a vehicle provided with an internal combustion engine, the travel control device comprising:
a calculation unit that calculates a travel resistance of the vehicle; and
a speed control unit that controls a speed of the vehicle,
wherein:
the speed control unit is configured to execute a burn-and-coast control that repeatedly executes a burn control which accelerates the vehicle by means of driving force of the internal combustion engine and a coasting control which stops generation of the driving force of the internal combustion engine so that the vehicle travels by means of inertia;
the burn control is configured to accelerate the vehicle at a predetermined acceleration until the speed of the vehicle reaches an upper limit of a predetermined vehicle speed range;
the coasting control is configured to make the vehicle travel by the inertia until the speed of the vehicle reaches a lower limit of the vehicle speed range; and
a vehicle speed width that is a width of the vehicle speed range and the acceleration are changed based on the calculated travel resistance.

2. The travel control device according to claim 1, wherein the calculation of the travel resistance by the calculation unit is executed based on a deceleration of the vehicle when the coasting control is executed.

3. The travel control device according to claim 1, further comprising:
a rainfall amount measurement unit that measures a rainfall amount around the vehicle,
wherein the calculation of the travel resistance by the calculation unit is executed based on the measured rainfall amount.

4. The travel control device according to claim 1, further comprising:
a wind speed measurement unit that measures a wind speed around the vehicle,
wherein the calculation of the travel resistance by the calculation unit is executed based on the measured wind speed.

5. The travel control device according to claim 1, further comprising:
an inclination measurement unit that measures inclination of the vehicle,
wherein the calculation of the travel resistance by the calculation unit is executed based on the measured inclination.

6. The travel control device according to claim 1, further comprising:
an air pressure measurement unit that measures an air pressure of a tire of the vehicle,
wherein the calculation of the travel resistance by the calculation unit is executed based on the measured air pressure.

7. The travel control device according to claim 1, further comprising:
a steering angle measurement unit that measures a steering angle of the vehicle,
wherein the calculation of the travel resistance by the calculation unit is executed based on the measured steering angle.

8. The travel control device according to claim 1, wherein
at least one of the vehicle speed width and the acceleration is set to be a smaller value as the calculated travel resistance becomes larger.

9. The travel control device according to claim 8, wherein
at least one of a drift amount that is a parameter indicating magnitude of resistance force that the vehicle receives when the speed of the vehicle is a specific value and a change rate that is a parameter indicating a change amount of the magnitude of the resistance force when the speed of the vehicle is changed by a specific amount is used as an index indicating the magnitude of the travel resistance.

10. The travel control device according to claim 9, wherein
an automatic following control that makes the vehicle travel to automatically follow another vehicle travelling ahead of the vehicle is executed.

11. The travel control device according to claim 10, wherein
the burn control and the coasting control are switched based on at least one of a vehicular distance between the vehicle and the other vehicle, and a relative speed of the vehicle against the other vehicle.

12. The travel control device according to claim 11, wherein
in the burn-and-coast control executed when the vehicular distance is in a predetermined first range, the vehicle speed range is defined as a range relating to the relative speed.

13. The travel control device according to claim 12, wherein
when the vehicular distance is less than a minimum distance defined as a distance shorter than a distance in the first range, a control that brakes the vehicle is executed, and
when the vehicular distance is less than the distance in the first range and more than the minimum distance, the coasting control is executed without executing the burn control.

14. The travel control device according to claim 12, wherein
when the vehicular distance is more than a distance in the first range, the automatic following control is ended, and the vehicle speed range is defined as a range relating to the speed of the vehicle against the road.

15. The travel control device according to claim 1, wherein
the vehicle is configured to travel by means of driving force of a rotating electric machine in addition to or instead of the driving force of internal combustion engine.
